(19) United States
(12) Patent Application Publication
(10) Pub. No.: US 2026/0050525 A1
(43) Pub. Date: Feb. 19, 2026

(54) Multi-Controller Drive Recovery

(71) Applicant: NetApp, Inc., San Jose, CA (US)

(72) Inventors: Suhas Girish Urkude, San Ramon, CA (US); Ben Franklin McDavitt, Wichita, KS (US); Sowkoor Sunad Bhandary, Morrisville, NC (US); Sanyukta Somani, Morrisville, NC (US); Bharath Kumar Nachenahalli Bhuthegowda, Newark, CA (US)

(21) Appl. No.: 18/926,934

(22) Filed: Oct. 25, 2024

Related U.S. Application Data
(60) Provisional application No. 63/684,140, filed on Aug. 16, 2024.

(51) Int. Cl. G06F 11/20; G06F 11/07; G06F 11/10; G06F 11/30

(52) U.S. Cl. CPC G06F 11/2094; G06F 11/0745; G06F 11/1092; G06F 11/3034

(57) ABSTRACT

The disclosure describes systems, devices, and methods for re-computing lost data in data storage environments. In an example embodiment, a method for rebuilding a failed storage device by multiple controllers in a data storage environment is provided. In the method, each of the controllers determines a failed state of a storage device in the data storage environment. Upon replacement of the failed storage device with a replacement storage device, each controller identifies corresponding storage allocation areas of the storage device, then rebuilds corresponding portions of the failed storage device at portions of the replacement storage device.

### RELATED APPLICATIONS

This application hereby claims the benefit and priority to U.S. Provisional Patent Application No. 63/684,140 , titled “DISTRIBUTED BACKGROUND RAID RESILIENCY OPERATIONS IN A SHARED-EVERYTHING ARCHITECTURE,” filed Aug. 16, 2024, which is hereby incorporated by reference in its entirety.

### TECHNICAL FIELD

Embodiments of the present disclosure relate generally to data storage technology, and in particular, to data recovery in data storage contexts.

### BACKGROUND

A typical architecture of a data storage environment includes a host device, a controller, and storage devices capable of storing data. The host device interfaces with users to receive input/output requests for accessing the storage devices, and the host device communicates the input/output requests to the controller. The controller then interfaces with the storage devices to access locations in the storage devices specified in the input/output requests. The input/output requests refer to read operations, in which the controller reads data from the storage devices, and write operations, in which the controller writes data to the storage devices.

A one-to-one architecture in data storage contexts refers to an arrangement in which each controller in a data storage environment accesses a specific subset of storage devices in the data storage environment but does not interface with nor control other subsets of storage devices. Problematically, adding or replacing controllers to increase compute power in the environment requires adding or replacing associated storage devices given the nature of the architecture. Not only does this increase the cost of upgrading or replacing existing hardware, but also this increases the time and processing capacity required to replace equipment. Furthermore, the maximum compute power and efficiency of the overall system is limited based on the capabilities and bandwidth of a controller as input/output operations are not parallelized among multiple controllers.

Other problems also exist with such architectures. For example, when a controller or associated storage device fails, the entire portion of the data storage environment may be unavailable until recovery operations are performed. To improve redundancy and recovery in one-to-one data storage architectures, each subset of storage devices can be made up of several inexpensive data disks and a parity disk that provide redundancy with respect to each other. However, these redundancy groups rely upon a single controller scheme and shared metadata, which means the storage devices of a given group still fail together when issues occur.

### SUMMARY

The technology described herein utilizes a shared-everything architecture for a data storage environment including multiple controllers and storage devices organized into redundancy groups (e.g., Redundant Array of Inexpensive Disks (RAID) groups). While generally applicable to numerous endeavors, such advantages may be especially useful in data storage environments and input/output (I/O) processing applications.

In this architecture, any controller can access any storage device, and each controller is allocated specific blocks of storage in each of the storage devices, which provides redundancy and improved storage and recovery efficiency. When a controller or storage device fails, the controllers collectively perform recovery operations to rebuild respective allocated blocks of storage to improve recovery speed and efficiency.

In an implementation, a method for performing cross-controller recovery operations to rebuild failed storage devices is provided. Controllers in a data storage environment perform such a method when the controllers identify an indication of a failed storage device resulting in lost data (i.e., data missing from the storage aggregate following the failure). Upon replacement of the failed storage device with a replacement storage device, each controller identifies corresponding storage allocation areas of the storage device, then rebuilds corresponding portions of the failed storage device at portions of the replacement storage device.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter. These and other features and aspects of various examples may be understood in view of the following detailed discussion and accompanying drawings.

### BRIEF DESCRIPTION OF THE DRAWINGS

For a more complete understanding of the present invention(s), and the advantages thereof, reference is now made to the following descriptions taken in conjunction with the accompanying drawings.

FIG. 1 illustrates an example data storage system in an implementation.

FIG. 2 illustrates a method for rebuilding failed disks of a data storage system in an implementation.

FIG. 3A illustrates an example operational scenario in an implementation.

FIG. 3B illustrates an example operational scenario in an implementation.

FIG. 4A illustrates an example operating environment in an implementation.

FIG. 4B illustrates an example operating environment in an implementation.

FIG. 5 illustrates an example operational sequence in an implementation.

FIG. 6 illustrates a computing system suitable for implementing the various systems, operational environments, architectures, environments, methods, processes, scenarios, sequences, and frameworks discussed below with respect to the other Figures.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Technology is disclosed herein that mitigates the problems discussed above with respect to data recovery in existing data storage architectures by utilizing a shared-everything architecture in which each controller is capable of accessing any storage device. In a shared-everything architecture, a single pool of storage devices (referring interchangeably to the terms storage device, disk, and drive) may be utilized for an entire cluster of controllers (referring interchangeably to the terms controllers and nodes) with equal and common access to the storage devices by the controllers.

The storage devices in the data storage environment are collectively referred to as a storage aggregate. The storage aggregate is divided into multiple RAID groups (e.g., sets of drives or disks providing RAID functionality, where RAID stands for Redundant Array of Independent Disks), and each RAID group includes one or more data disks and one or more parity disks that provide redundancy with respect to each other. The arrangement of the RAID groups, and the storage devices in each RAID group, is referred to as the aggregate layout. In defining the aggregate layout, each controller in the data storage environment may be allocated a range of blocks (e.g., logical or physical address spaces) on each storage device across all the storage devices within the same RAID group (the blocks across all the storage devices being referred to as a stripe). This allows each controller to write in parallel to the same set of storage devices without corrupting each other's data.

The ownership of such ranges by individual controllers is tracked in filesystem metadata (e.g., WAFL) stored on one or more of the storage devices in the aggregate. Problematically, a single pool of storage in shared-everything architectures requires the aggregate to encompass all the disks in the cluster, which consequently, requires the same metadata to be referred to by all the storage devices. For such a cluster, potentially hundreds of controllers may need to access and rely upon the same metadata. There are times the storage devices within a RAID group can fail which requires the addition of a replacement drive and reconstruction of data by using remaining drives from the RAID group. Due to the ownership of block ranges being distributed across all the controllers in the cluster, a single controller might not be able to reconstruct the entire drive without coordinating with other controllers and without consulting the filesystem metadata. Also, the ownership of the block ranges may change during the reconstruction operation. This poses a significant challenge for the drive reconstruction process as it becomes cluster-wide.

To solve the above problem, a system disclosed herein may utilize multiple controllers to recover lost data and rebuild failed storage devices of a cluster. During recovery operations, the system implements techniques to track recovery progress on a per-controller basis with respect to a storage device undergoing reconstruction. Each controller can independently track its progress for the block ranges owned by that controller. Each controller may provide a progress map and a target-map that it wants to achieve for that disk. The progress may be persisted at a location that is away from the disks, but it may still be in some form of persistent media which may be shared across all the controllers. A replicated database can be used to which all the controllers can write. All the controllers in the cluster can persist their progress onto the shared location periodically and independent of other controllers. A controller (also referred to in some instances as a RAID orchestrator or orchestration engine) may be responsible for consolidating the progress from all the controllers by referring to the persistent records made by each controller. When the RAID orchestrator determines that consolidated progress-map matches with the target-map for the drive, it may mark that operation being done. Thus, when a storage device fails, the re-build of the storage device can be farmed out to each of the multiple controllers to improve recovery speed and efficiency.

This scheme may allow the ownership of block ranges to be changed while a long-running operation like reconstruction is ongoing, the progress to be carried out by the node taking over in case of system/node outage, and drive level and RAID group level operations to be tracked in the similar manner, among other benefits.

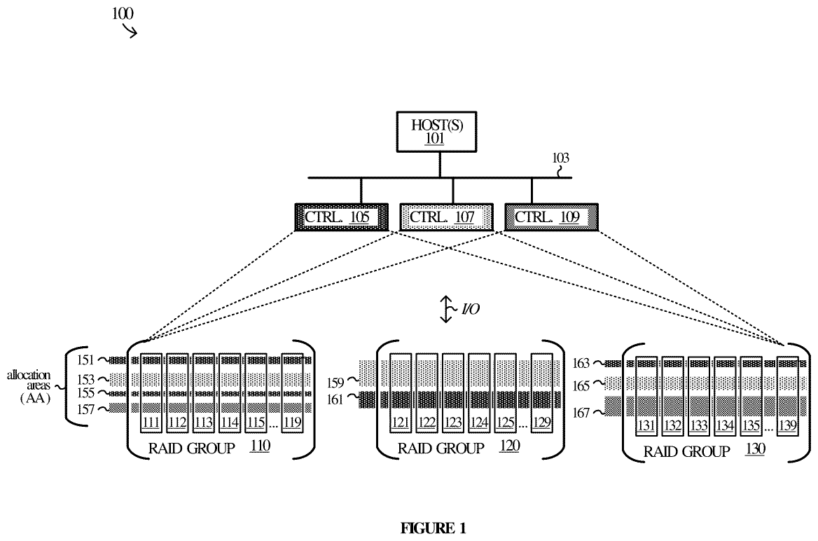

FIGS. 1, 2, 3A, 3B, 4A, 4B, and 5 below illustrate and describe additional details of such systems, devices, and methods.

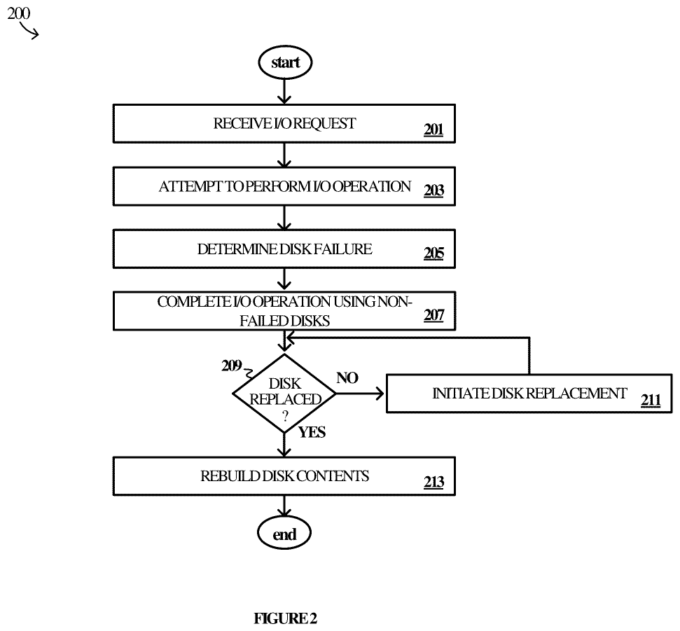

FIG. 1 illustrates an example data storage system in an implementation and references elements of FIG. 1. FIG. 1 shows system 100, which includes host(s) 101, controllers 105, 107, and 109, and RAID groups 110, 120, and 130. RAID groups 110, 120, and 130 may each include a plurality of storage devices, including data disks and parity disks. In various embodiments, controllers 105, 107, and 109 may be configured to perform data reconstruction and management processes, such as process 200 of FIG. 2.

System 100 is representative of a data storage system operating in a data storage environment. System 100 includes multiple controllers and multiple storage devices (e.g., drives, disks) arranged in a shared-everything architecture such that each of the controllers is capable of accessing any of the storage devices. In particular, controllers 105, 107, and 109 can perform input/output (I/O) operations (e.g., read operations, write operations) with all of the storage devices of RAID groups 110, 120, and 130.

Host(s) 101 (hereinafter referred to as host 101) is representative of one or more host servers, applications, devices, systems, or the like, capable of providing I/O operations to controllers 105, 107, and 109. Host 101 may include and may be implemented in hardware, software, and/or firmware, as well as combinations and variations thereof.

By way of example, host 101 is representative of a server running an application that interfaces with system 100 via network 103 to read from and write to the storage devices of system 100. An end user accesses host 101, or the application thereof, via a user device (e.g., a computer, a tablet, a smartphone), and provides requests to perform I/O operations via one of controllers 105, 107, or 109 to access the storage devices. In such an example, host 101 may be running a data storage administration and management application representative of data management software (e.g., NetApp ONTAP) capable of providing data management operations such as storage configuration, data protection, network setup and management, and risk and node and cluster performance monitoring, among other functions. Host 101 provides the I/O requests to controllers 105, 107, and/or 109, using an interface (e.g., a command line interface (CLI)) to the application over an application programming interface (API) (e.g., a RESTful API).

Controllers 105, 107, and 109 are representative of control devices or systems that each include one or more processing devices capable of controlling, managing, and accessing each of the storage devices of system 100. Examples of the processing devices may include one or more central processing units (CPUs), general purpose processors, Application Specific Integrated Circuits (ASICs), microcontroller units (MCUs), digital signal processors (DSPs), field-programmable gate arrays (FPGAs), and the like. In some examples, controller 105 may represent two or more controllers coupled as high availability (HA) pairs for at least fault tolerance and back-up purposes.

In various examples, controllers 105, 107, and 109 are configured to run an instance of the data storage management application also running on host 101 to perform the I/O operations received from host 101. As such, the controllers interface with host 101 via the application in accordance with a storage network and access protocol, such as Non-Volatile Memory Express (NVMe). Other protocols such as Network File System (NFS), Server Message Block protocol (SMB), Internet Small Computer System Interface (iSCSI), Fiber Channel (FC), Fiber Channel over Ethernet (FCoE), and the like may be contemplated. Controllers 105, 107, and 109 may further interface with the storage devices of RAID groups 110, 120, and 130 over one of the network protocols at which the controllers perform the I/O operations.

RAID groups 110, 120, and 130 are each representative of a group or array of storage devices that provide redundancy with respect to one another. Examples of the storage devices include flash disks and/or capacity drives, such as hard-disk drives (HDDs) and solid state drives (SSDs), as well as combinations and variations thereof. As illustrated in system 100, RAID group 110 includes data disks 111, 112, 113, 114, and 115, and parity disk 119, RAID group 120 includes data disks 121, 122, 123, 124, and 125, and parity disk 129, and RAID group 130 includes data disks 131, 132, 133, 134, and 135, and parity disk 139 (all collectively referred to as disks or drives). In some embodiments, each RAID group may include additional or fewer data disks and/or parity disks. Additionally, system 100 may include additional or fewer RAID groups that can be accessed by each of controllers 105, 107, and 109.

In various embodiments, each controller of system 100 interfaces with RAID groups 110, 120, and 130, as well as each data and parity disk of the RAID groups, based on the shared-everything layout. In other words, controllers 105, 107, and 109 each have access to some or all of the RAID groups, and data and parity disks thereof, and provide I/O requests to the disks to write to or read from the disks of the RAID groups.

In various embodiments, the disks in each RAID group are divided into allocation areas, such that each controller is allocated a specific location from which to read data and to which to write data. In particular, each allocation area corresponds to one of controllers 105, 107, and 109. For example, RAID group 110 includes allocation areas 151, 153, 155, and 157, which include portions of storage within each of data disks 111, 112, 113, 114, and 115 of RAID group 110. Allocation areas 151 and 155 are associated with controller 105, allocation area 153 are associated with controller 107, and allocation area 157 are associated with controller 109. RAID group 120 includes allocation areas 159 and 161. Allocation area 159 is associated with controller 107, and allocation area 161 is associated with controller 105. RAID group 130 includes allocation areas 163, 165, and 167. Allocation area 163 is associated with controller 105, allocation area 165 is associated with controller 107, and allocation area 167 is associated with controller 109. Additional or fewer allocation areas may be included in each RAID group, as well as combinations and variations thereof with respect to each controller of system 100.

In operation, each controller performs I/O operations and accesses respective allocation areas of RAID groups based on the I/O operations. By way of example, for a write operation by controller 105 to disks of RAID group 110, controller 105 writes data to allocation area 151 at each disk of RAID group 110. Upon completion of the write operation, controller 105 may additionally perform a parity operation (e.g., an XOR operation based on the data stored in the data disks of RAID group 110) at parity disk 119. If any of the write operations at the data disks and/or the parity operation at parity disk 119 fails (e.g., the I/O operation times-out, controller 105 receives an error), controller 105 determines a failed state of one or more of the disks of RAID group 110 and initiates recovery operations to replace the failed disk(s) and rebuild data from the failed disk(s) on the replacement disk(s).

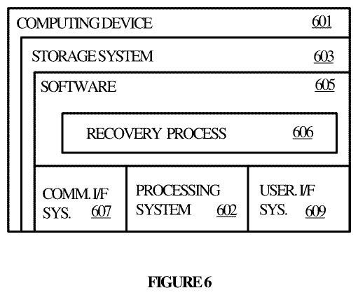

FIG. 2 illustrates a method for rebuilding disks of a data storage system in an implementation. Process 200 may be employed by a computing device, such as a controller of system 100 (e.g., one of controllers 105, 107, and 109), an example of which is provided by computing system 601 of FIG. 6. Accordingly, process 200 may be implemented in hardware, software, and/or firmware, and may be implemented in program instructions executable by one or more processors of the computing device. The program instructions direct the computing device to operate in accordance with the steps of process 200, which reference elements of FIG. 1.

The following operations follow the previous example described in FIG. 1 with respect to controller 105 for the sake of simplicity and convenience. The operations of process 200 may be performed by any one or more of the controllers of system 100 to rebuild one or more replacement disks with data previously stored on one or more failed disks.

To begin, in operation 201, controller 105 receives an I/O request from host 101. The I/O request may correspond to a read operation at the disks of RAID group 110. In particular, the read request may identify a set of disks at which to perform the read operation and data to be read from the identified disks.

In operation 203, controller 105 attempts to perform the read operation at the disks of RAID group 110. This entails reading data from each of the data disks of RAID group 110 at a portion of the data disk associated with an allocation area corresponding to controller 105. Specifically, controller 105 reads data from allocation area 151 at each of data disks 111, 112, 113, 114, and 115. In response to performing the read operation at the data disks, each of the data disks provides the data and an acknowledgement to controller 105. In this example, however, data disk 115 might not return data or an acknowledgement to controller 105 as data disk 115 has failed.

In operation 205, controller 105 identifies that data disk 115 has failed. In some examples, controller 105 identifies that data disk 115 has failed, or is otherwise unavailable, based on the failure to receive data and/or an acknowledgement from data disk 115. In some examples, controller 105 additionally, or instead, identifies the failure based on detecting a failure to read from data disk 115 within a threshold amount of time resulting in a time-out of communications between controller 105 and data disk 115.

Upon identifying that data disk 115 has failed, permanently or temporarily, in operation 207, controller 105 completes the I/O request using data from the other disks of RAID group 110. In particular, controller 105 uses the data read from data disks 111, 112, 113, and 114 captured based on performing the read operation (i.e., using data stored in-memory by controller 105 while performing the read operation), reads parity data from parity disk 119, and computes data corresponding to data disk 115 (i.e., data that would have been read from data disk 115 during the read operation if not for the failure of data disk 115) using the data from the other data disks and the parity data. Controller 105 then provides the data associated with the I/O request to host 101.

In operation 209, controller 105 determines whether data disk 115 has been replaced by a replacement controller or not. In various examples, upon replacement of a failed disk, controller 105, among other controllers, may receive an indication of the addition of the replacement disk to the storage aggregate. If controller 105 has not received such an indication, controller 105 determines that data disk 115 has not been replaced.

Accordingly, in operation 211, controller 105 initiates a disk replacement process during which a replacement disk is located and added to RAID group 110 to replace data disk 115.

Upon replacement of data disk 115, in operation 213, controller 105 rebuilds data that was stored on data disk 115 and that is no longer available to controller 105 or other controllers of system 100 based on the failure of data disk 115 (also referred to as “lost” or “missing” data herein). In various examples, controller 105 rebuilds data of allocation areas owned by controller 105 (e.g., allocation area 151, allocation area 155). The rebuild of such data may entail reading data from other disks of RAID group 110 at portions of the disks associated with respective allocation areas owned by controller 105, rebuilding the missing data using the data from the other disks, and storing the re-computed data at portions of the replacement disk associated with the respective allocation areas owned by controller 105.

By way of a particular example with respect to allocation area 151, controller 105 reads user data from data disks 111, 112, 113, and 114 at allocation area 151 of each data disk, reads parity data from parity disk 119 at allocation area 151 of parity disk 119, computes new data for the replacement disk representative of the data that was stored on data disk 115 at allocation area 151 of data disk 115 prior to the failure of data disk 115, and stores the new data at allocation area 151 of the replacement disk. Controller 105 repeats this process for other allocation areas owned by controller 105, such as allocation area 155. Further, other controllers of system 100 also perform such rebuild operations for respective allocation areas upon identifying the failure of data disk 115. In this way, each controller of system 100 may perform rebuild operations to re-compute data once stored on failed data disk 115 in parallel, which may not only increase efficiency of the rebuild of replacement disks but also increase processing capacity of the controllers as each controller only rebuilds portions of the replacement disk associated with allocation areas corresponding to the controllers.

In some examples, each controller tracks respective progress with respect to reconstructing contents of failed data disk 115 at a replacement disk. Each controller provides indications of progress to controller 105 (or another controller), and upon controller 105 determining the individual and/or collective progress meets or exceeds a threshold progress level, controller 105 directs the controllers to write the re-computed data to the replacement data disk. Alternatively, in some such examples, controller 105 tracks the progress of all the controllers, and upon determining the collective progress meets or exceeds the threshold progress level, controller 105 directs the controllers to write the re-computed data to data disk 115 or the replacement data disk.

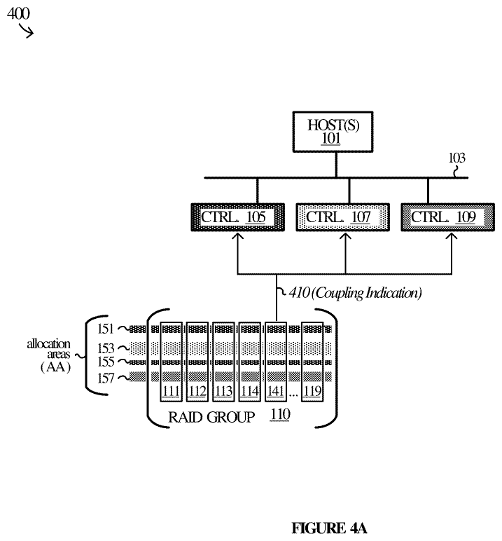

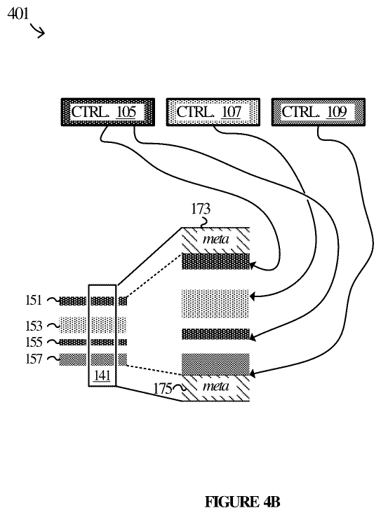

In some examples, following the replacement of data disk 115 with a replacement disk, one of the controllers of system 100 updates metadata corresponding to a layout of the RAID group (e.g., metadata stored in metadata sub-section 173 and/or 175 of FIG. 4B below) and/or to a layout of the entire storage aggregate to reflect the changing of the layout as the failed disk is removed from the storage aggregate and replaced by another disk. By updating the layout metadata, the controllers of system 100 can identify the change in layout and perform subsequent I/O operations using the updated layout that includes the replacement disk.

Advantageously, each controller assists in the rebuild of lost data based on a failed disk in this shared-everything architecture, which parallelizes the recovery operations and improves data recovery efficiency with respect to at least time and computing requirements by the controllers of the data storage environment.

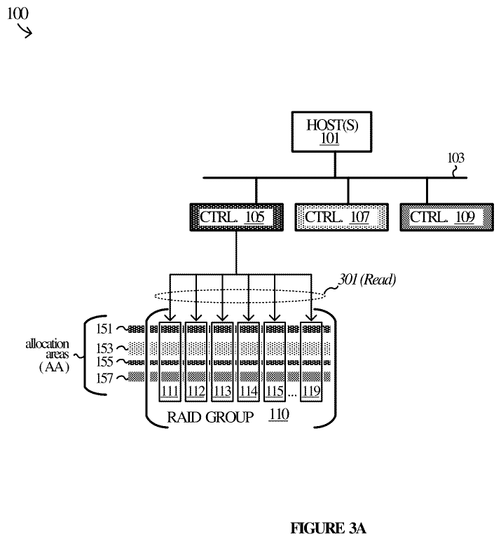

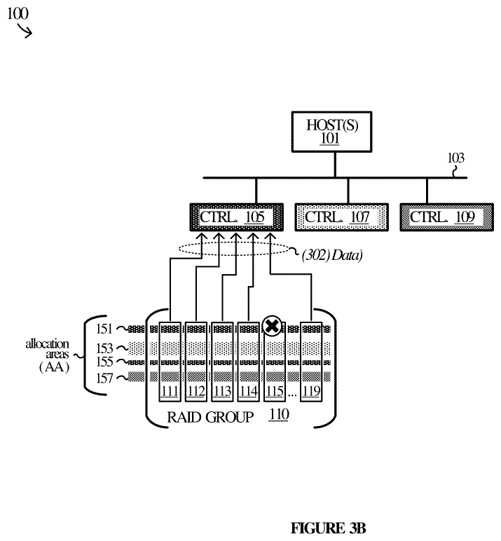

FIGS. 3A and 3B illustrate operational scenarios involving elements of system 100.

In FIG. 3A, controller 105 is configured to perform read I/O operations to disks of RAID group 110. In particular, controller 105 receives a read request from host 101 via network 103 corresponding to a read of data to the disks of RAID group 110. In response to receiving the request from host 101, controller 105 determines which allocation area(s) controller 105 is assigned, and controller 105 performs read 301 to read data from each allocation area of each disk of RAID group 110 associated with controller 105.

In FIG. 3B, in response to read 301 by controller 105, controller 105 reads data 302 from the disks of RAID group 110, and optionally, the disks output an acknowledgement of completion of the read to controller 105. More specifically, based on read 301, controller 105 reads data 302 from data disks 111, 112, 113, and 114, and parity disk 119, and as such, the disks output read acknowledgement signals to controller 105 to indicate a successful read. However, as illustrated in FIG. 3B, data disk 115 has failed and data is not read from data disk 115. Accordingly, if controller 105 does not receive data or an acknowledgement signal from data disk 115 after a pre-determined amount of time (e.g., a threshold time), controller 105 determines that data disk 115 is in a failed state. In some examples, data disk 115 alternatively outputs an indication of failure based on failing.

After determining that data disk 115 is in the failed state, controller 105 completes the I/O request for host 101 by computing data that would have been read from data disk 115 if not for the failure of data disk 115. Computing this data may entail performing a parity operation (e.g., an XOR operation) using data 302 from the other disks of RAID group 110. For example, by using data from data disks 111, 112, 113, 114, and parity data from parity disk 119, controller 105 can determine the data associated with data disk 115 as the other disks for a redundancy group to provide resiliency and recovery of data.

FIG. 4A illustrates an example operating environment 400 in data disk 115 is replaced by data disk 141 following the failure of data disk 115. As such, operating environment 400 references and includes elements of FIG. 1, such as controllers 105, 107, and 109 and RAID group 110 of system 100.

In operating environment 400, following the failure of a data disk, data disk 141 is added to RAID group 110. Upon being physically coupled to a drive shelf (e.g., an enclosure, a rack) that physically holds the disks of RAID group 110, data disk 141 provides coupling indication 410 to controllers 105, 107, and 109. Coupling indication 410 may include a signal indicative of the addition of data disk 141 to the storage aggregate.

Coupling indication 410 may further include metadata associated with data disk 141, such as metadata indicative of characteristics of the disk (e.g., size, type, capacity, durability).

Referring next to FIG. 4B, FIG. 4B illustrates operating environment 401 in which data disk 141 is reconstructed by controllers 105, 107, and 109 in parallel following the addition of data disk 141 to RAID group 110 in operating environment 400. As such, operating environment 401 references and includes elements of FIG. 1, such as controllers 105, 107, and 109.

As illustrated in operating environment 401, data disk 141 includes a plurality of addresses organized into allocation areas 151, 153, 155, and 157, metadata sub-section 173, and metadata sub-section 175. Metadata sub-sections 173 and 175 may include metadata corresponding to data disk 141, to controllers 105, 107, 109, and to RAID group 110 as well as other data disks and parity disks of RAID group 110, among other information (e.g., layout metadata). Accordingly, metadata sub-sections 173 and/or 175 indicate the allocation areas of data disks 115, among other data disks, the controllers associated with each of the allocation areas, the other disks in RAID group 110, and I/O operations corresponding to each bit of data stored in data disk 115, among other information.

Based on a failure of a data disk in RAID group 110, one of the controllers of system 100, such as controller 105, operates as a recovery orchestrator to recover data stored on the failed data disk and reconstruct data disk 141 using the recovered data. In operation, to rebuild data disk 141, each of controllers 105, 107, and 109 identifies the coupling of data disk 141 to RAID group 110 (in operating environment 400) and rebuilds respective portions of data disk 141 corresponding to allocations areas associated with the controllers. In particular, each controller identifies respective allocations areas of data disk 141, such as by reading metadata sub-sections 173 and/or 175 of data disk 141.

Upon determining the allocation areas, each controller re-computes data previously stored on the failed data disk to rebuild respective allocation areas of data disk 141. In various examples, re-computing data entails reading data stored on other data disks of RAID group 110 in corresponding allocation areas, reading parity data stored on parity disk 119 of RAID group 110 in corresponding allocation areas, and performing a parity operation using the data and the parity data. Based on each of the controllers re-computing respective data, one of the controllers (e.g., controller 105) directs the controllers to write the newly computed data to respective allocation areas of data disk 141 to reconstruct the storage device.

Advantageously, such rebuilding by each controller may occur in parallel and by using processing capacity of each controller as opposed to a rebuild by a single controller over a duration. In this way, rebuilding failed disks may occur quicker and with fewer processing resources from individual controllers as the rebuild may be farmed out to multiple controllers that each operate within one or more particular allocation areas of the failed disk.

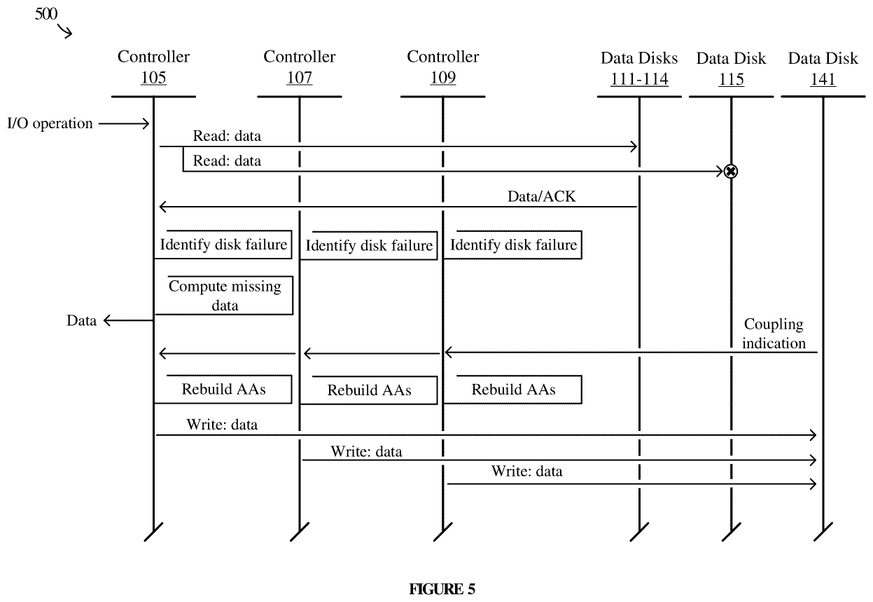

FIG. 5 illustrates operational sequence 500 demonstrative of an example sequence of steps performed by elements of system 100, which includes and references elements of system 100 and operating environment 400. In particular, operational sequence 500 includes steps performed by controllers 105, 107, and 109 with respect to data disks 111, 112, 113, 114, 115, and 141.

To begin operational sequence 500, controller 105 receives an I/O request from host 101 corresponding to an I/O operation (e.g., a read operation) at data disks 111-115 of RAID group 110. Accordingly, controller 105 reads data specified in the I/O operation from data disks 111, 112, 113, 114, and 115. In response to reading data from the data disks, data disks 111, 112, 113, and 114 output an acknowledgement to controller 105. However, data disk 115 may have failed, and as such, does not return an acknowledgement.

After a duration without receiving an acknowledgement from data disk 115, controller 105 identifies a failure of data disk 115. Other controllers also identify the failure of data disk 115. Based on identifying the failure of data disk 115, controller 105 completes the read operation using the other data read from data disks 111-114 as well as parity data from parity disk 119. Controller 105 provides the data to host 101 following completion of the I/O request.

Following the failure of data disk 115, data disk 141 is added to the storage aggregate. In this example, data disk 141 is assigned to RAID group 110 to replace data disk 115 and outputs a coupling indication to controllers 105, 107, and 109. Upon receiving the coupling indication, controllers 105, 107, and 109 all initiate rebuild operations to reconstruct data disk 141 with the data previously stored on data disk 115 and currently missing from RAID group 110 based on the failure of data disk 115.

In various examples, the controllers reconstruct data disk 141 by determining parity data that corresponds to the data of data disk 115 stored in respective allocation areas of parity disk 119, and further, by determining user data that corresponds to one or more I/O operations associated with the data stored in other data disks of RAID group 110. Each controller re-computes the lost data based on the respective parity data and user data. Then, each controller can write the re-computed data to data disk 141 to rebuild data disk 141 in accordance with data previously stored on data disk 115.

It may be appreciated that developing strategies to mitigate the impact of data loss and disruption of requests to access data and corresponding storage devices due to storage device management processes has become important for enterprises and end users. Failures of storage devices, updates or upgrades to storage devices, and/or failures of controllers with which to manage such storage devices may occur and interrupt access to data.

To mitigate the downtime and disruption introduced when performing storage device upgrades, rebuilds, replacements, and the like, enterprises may utilize various systems, methods, and devices as described herein to manage data management systems, clusters thereof, nodes thereof, and RAID groups including various storage devices (e.g., disks), as well as data and metadata thereof.

The disclosure describes systems, methods, and devices for managing storage devices and the layout thereof in a data storage environment, managing access to the storage devices, and the like in shared-everything data storage system architectures, as well as for at least: 1) utilizing all controllers having allocation areas associated with a failed storage device to rebuild the failed storage device; 2) performing rebuild and recovery operations in parallel with respect to controllers in a data storage system; and 3) tracking data storage operations and recovery operations on a per-controller basis to provide insight into storage device failure and reconstruction.

Various embodiments of the present technology provide for a wide range of technical effects, advantages, and/or improvements to computing systems and components. For example, various embodiments may include one or more of the following technical effects, advantages, and/or improvements: 1) management of access to storage devices; 2) non-disruptive access to storage devices; 3) management of storage devices and RAID groups of storage devices; 4) scalable controllers and storage devices in a distributed shared-everything architecture; 5) scalable RAID group layouts; and 6) ability to protect against and reconcile updates to storage devices, and metadata thereof, from multiple controllers.

FIG. 6 illustrates computing system 601, which is representative of any system or collection of systems in which the various applications, processes, services, and scenarios disclosed herein may be implemented. Examples of computing system 601 include, but are not limited to server computers, web servers, cloud computing platforms, and data center equipment, as well as any other type of physical or virtual server machine, container, and any variation or combination thereof. (In some examples, computing system 601 may also be representative of desktop and laptop computers, tablet computers, smartphones, and the like.)

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes and implements recovery process 606, which is representative of the processes discussed with respect to the preceding Figures. When executed by processing system 602, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may include a microprocessor and other circuitry that retrieves and executes software 605 from storage system 603.

Processing system 602 may be implemented within a single processing device but may also be distributed across multiple processing devices or sub-systems that cooperate in executing program instructions. Examples of processing system 602 include general purpose central processing units, microcontroller units, graphical processing units, application specific processors, integrated circuits, application specific integrated circuits, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 603 may be implemented as a single storage device but may also be implemented across multiple storage devices or sub-systems co-located or distributed relative to each other. Storage system 603 may comprise additional elements, such as a controller capable of communicating with processing system 602 or possibly other systems.

Software 605 (including recovery process 606) may be implemented in program instructions and among other functions may, when executed by processing system 602, direct processing system 602 to operate as described with respect to the various operational scenarios, sequences, and processes illustrated herein. For example, software 605 may include program instructions for implementing data, data storage, controller, drive, disk, and data storage management processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S. C. § 112(f) will begin with the words “means for”, but use of the term “for” in any other context is not intended to invoke treatment under 35 U.S. C. § 112(f). Accordingly, the applicant reserves the right to pursue additional claims after filing this application to pursue such additional claim forms, in either this application or in a continuing application.

What is claimed is:

1. A computing apparatus comprising:
one or more computer-readable storage media; and
program instructions stored on the one or more computer-readable storage media executable by a processing device that, based on being read and executed by the processing device, direct the processing device to:
receive a request to perform an input/output operation at a drive in a data storage environment comprising a storage aggregate including multiple drives, and multiple controllers capable of communicating with each of the drives in the storage aggregate;
attempt to perform the input/output operation at a portion of the drive associated with an allocation area corresponding to a controller of the multiple controllers;
identify a failure of the drive based on attempting to perform the input/output operation; and
in response to the drive being replaced by a replacement drive, rebuild the portion of the drive at a corresponding portion of the replacement drive associated with the allocation area of the controller.

2. The computing apparatus of claim 1, wherein the program instructions further direct the processing device to, in response to detecting the failure of the drive, initiate a rebuild process comprising replacing the drive with the replacement drive.

3. The computing apparatus of claim 1, wherein the program instructions further direct the processing device to, in response to detecting the failure of the drive, complete the input/output operation using data from a subset of drives in the storage aggregate, wherein the drive and the subset of drives belong to a redundancy group.

4. The computing apparatus of claim 3, wherein to complete the input/output operation using data from the subset of drives in the storage aggregate, the program instructions direct the processing device to:
read user data from data drives of the subset of drives;
read parity data from a parity drive of the subset of drives; and
compute input/output data corresponding to the input/output operation based on the user data and the parity data.

5. The computing apparatus of claim 1, wherein to rebuild the portion of the drive at the corresponding portion of the replacement drive, the program instructions direct the processing device to:
read user data from portions of data drives of a subset of drives of a redundancy group of the storage aggregate that includes the replacement drive, wherein the portions are associated with the allocation area of the controller;
read parity data from a portion of a parity drive of the subset of drives associated with the allocation area of the controller;
compute new data to be stored at the replacement drive based on the user data and the parity data; and
store the new data at the corresponding portion of the replacement drive.

6. The computing apparatus of claim 5, wherein the redundancy groups comprise Redundant Array of Independent Disks (RAID) groups.

7. The computing apparatus of claim 1, wherein the program instructions further direct the processing device to, in response to the drive being replaced by the replacement drive, update instances of layout metadata stored on the drives corresponding to a layout of the drives in the storage aggregate to reflect a change to the layout based on replacing the drive with the replacement drive.

8. A method of rebuilding a failed drive of a data storage environment comprising a storage aggregate that includes multiple drives, and multiple controllers capable of communicating with each of the drives in the storage aggregate, the method comprising:
identifying a failure of a drive in the storage aggregate; and
in response to the drive being replaced by a replacement drive, rebuilding, by the multiple controllers, corresponding portions of the drive at portions of the replacement drive.

9. The method of claim 8, wherein the corresponding portions of the drive and the portions of the replacement drive are associated with allocation areas corresponding to the multiple controllers.

10. The method of claim 8, wherein rebuilding, by the multiple controllers, the corresponding portions of the drive at the portions of the replacement drive comprises, for each of the multiple controllers, rebuilding a respective one or more portions of the portions associated with one or more allocation areas of the allocation areas corresponding to the controller.

11. The method of claim 9, wherein rebuilding the respective one or more portions comprises:
reading user data from portions of data drives of a subset of drives of a redundancy group of the storage aggregate that includes the replacement drive, wherein the portions are associated with the allocation area of the controller;
reading parity data from a portion of a parity drive of the subset of drives associated with the allocation area of the controller;
computing new data to be stored at the replacement drive based on the user data and the parity data; and
storing the new data at the portion of the replacement drive.

12. The method of claim 9, wherein the redundancy groups comprise Redundant Array of Independent Disks (RAID) groups.

13. The method of claim 8, further comprising, in response to the drive being replaced by the replacement drive, updating, by one of the controllers, instances of layout metadata stored on the drives corresponding to a layout of the drives in the storage aggregate to reflect a change to the layout based on replacing the drive with the replacement drive.

14. A system comprising:
a storage aggregate comprising multiple drives; and
multiple controllers capable of communicating with each of the drives, wherein each controller of the multiple controllers is configured to:
receive a request to perform an input/output operation at one or more of the drives;
attempt to perform the input/output operation at respective portions of the one or more drives associated with an allocation area corresponding to the controller;
identify a failure of a drive of the one or more drives based on attempting to perform the input/output operation; and
in response to the drive being replaced by a replacement drive, rebuild a portion of the drive at a corresponding portion of the replacement drive.

15. The system of claim 14, wherein each controller is further configured to, in response to detecting the failure of the drive, initiate a rebuild process comprising replacing the drive with the replacement drive.

16. The system of claim 14, wherein each controller is further configured to, in response to detecting the failure of the drive, complete the input/output operation using data from a subset of drives in the storage aggregate, wherein the drive and the subset of drives belong to a redundancy group.

17. The system of claim 16, wherein to complete the input/output operation using data from the subset of drives in the storage aggregate, each controller is configured to:
read user data from data drives of the subset of drives;
read parity data from a parity drive of the subset of drives; and
compute input/output data corresponding to the input/output operation based on the user data and the parity data.

18. The system of claim 14, wherein to rebuild the portion of the drive at the corresponding portion of the replacement drive, each controller is configured to:
read user data from portions of data drives of a subset of drives of a redundancy group of the storage aggregate that includes the replacement drive, wherein the portions are associated with the allocation area of the controller;
read parity data from a portion of a parity drive of the subset of drives associated with the allocation area of the controller;
compute new data to be stored at the replacement drive based on the user data and the parity data; and
store the new data at the corresponding portion of the replacement drive, wherein the corresponding portion is associated with the allocation area of the controller.

19. The system of claim 18, wherein the redundancy groups comprise Redundant Array of Independent Disks (RAID) groups.

20. The system of claim 14, wherein each controller is further configured to, in response to the drive being replaced by the replacement drive, attempt to update instances of layout metadata stored on the drives corresponding to a layout of the drives in the storage aggregate to reflect a change to the layout based on replacing the drive with the replacement drive.
